(19) United States
(12) Patent Application Publication
(10) Pub. No.: US 2008/0006080 A1
(43) Pub. Date: Jan. 10, 2008

(54) Leak Detector With a Sniffer Probe

(75) Inventor: Daniel Wetzig, Koln (DE)

Correspondence Address: MARJAMA MULDOON BLASIAK & SULLIVAN LLP, 250 SOUTH CLINTON STREET, SUITE 300, SYRACUSE, NY, 13202, US

(73) Assignee: Inficon GmbH, Koln (GB)

(21) Appl. No.: 11/629,286

(22) PCT Filed: Apr. 28, 2005
(86) PCT No.: PCT/EP05/02614

§ 371 Date: Aug. 3, 2007

(30) Foreign Application Priority Data
Jun. 18, 2004 (DE) 10 2004 029 637.5

(51) Int. Cl. G01M 3/04

(52) U.S. Cl. 73/40.7

(57) ABSTRACT

In a leak detector with a sniffer probe, the invention provides that the sniffer tube (12), which is provided in the form of a throttling capillary line and which leads from the sniffer probe (10) to a vacuum chamber (13), has an inner cross-sectional area that varies in the longitudinal direction. The cross-sectional area enlarges in the direction of flow of the drawn-in gas, thus from the inlet (11) to the vacuum chamber. This reduces the dead time, i.e. the transit time of the gas through the sniffer tube (12).

The invention refers to a leak detector with a sniffer probe connected to a vacuum chamber through a sniffer tube in th form of a throttling capillary line.

DE 44 45 829 A1 (Leybold A G) describes a counter-current sniffer leak detector with a high vacuum pump stage at the end of a sniffer tube. A sniffer tube of approximately 4 m in length and having an inner diameter of about 0.4 mm is used. The sniffer tube applies the throttling effect necessary to maintain the vacuum generated at its outlet end.

DE-OS 24 41 124 describes a leak detector with a sniffer tube, wherein the tube has a relatively large diameter. Between a vacuum chamber and a mass spectrometer, a throttling point is provided immediately in front of the mass spectrometer. By providing the throttling point immediately in front of the mass spectrometer, the vacuum pump can convey the gas to be examined more quickly from the inlet of the probe to immediately in front of the throttle point, i.e. to the mass spectrometer. Thereby, the response time that depends on the length of the probe tube is reduced.

In a leak detector, in which the sniffer tube is designed as a capillary line, the pneumatic resistance is distributed over the entire length of the sniffer tube. The pressure in the capillary drops in good approximation linearly down to the value prevailing at the outlet opening. For a defined tube length and a constant cross section, the dead time can be calculated from the quotient of the quantity of gas (volume×mean pressure) and flow. The portions of the capillary at high pressure make a greater contribution to the dead time than the portions that are at low pressure.

It is an object of the present invention to provide a leak detector with a capillary sniffer tube that has short dead times and therefore has short response times.

The leak detector of the present invention is defined by claim 1. According thereto, the sniffer tube has an inner cross-sectional surface varying in the longitudinal direction, the cross-sectional surface increasing in the flow direction of the gas aspirated.

The invention provides that the greatest flow resistance of the sniffer tube is close to the inlet opening. Thereby, a great reduction of pressure already occurs in the vicinity of the inlet opening. However, care has to be taken that no blocking of the flow occurs and the laminar flow in the capillary does not become turbulent. These conditions can be obtained with a capillary having a cross section increasing in the flow direction.

Generally, the flow cross-sectional area of the capillary may follow an optional profile. A capillary with a continuously increasing cross section requires greater production efforts than a capillary with a cross section increased stepwise. Therefore, a stepped capillary has to be preferred. It also causes a considerable reduction of the dead time. The choice of the lengths and the cross sections of the portions can be optimized. The problem of optimizing is influenced by the pressure at the inlet opening and at the outlet and depends on the desired overall length of the line.

According to a preferred embodiment of the invention, it is provided that for tube lengths of less than 5 m, the diameter of the smallest cross section of the sniffer tube must not be greater than 700 μm. Thus, a sufficiently short dead time of this line section is ensured.

In a preferred embodiment of the invention it is provided each portion conveys at least approximately the same flow, the flow qₚᵥ being obtained as follows:

$${q}_{pv} = \frac{õ {d}^{4}}{256 l η} ( {p}_{1}^{2} - {p}_{2}^{2} )$$

where p₁ and p₂ are the pressures at the ends of the portion, d is the diameter, l is the length, and η is the dynamic viscosity of the carrier gas, generally air.

Basically, the sniffer tube should convey a large flow (volume of gas per unit time) and have a short dead time (transit time of the molecules from the inlet to the outlet).

The following is a detailed description of an embodiment of the invention with reference to the drawings.

In the Figures:

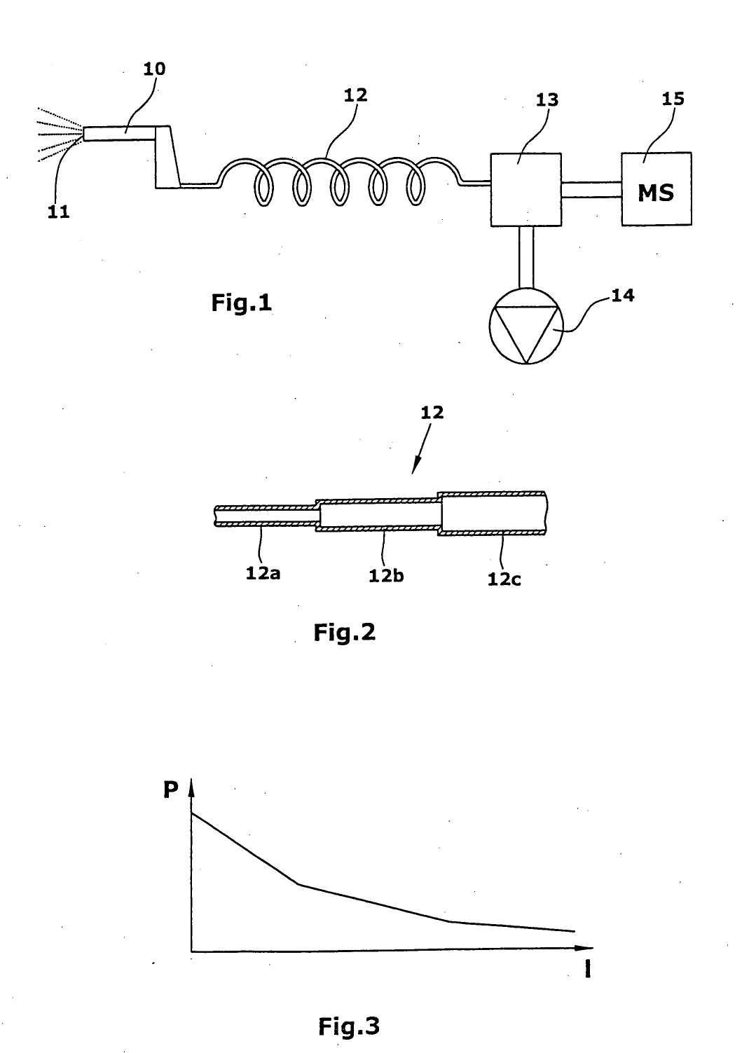

FIG. 1 is a schematic illustration of the leak detector,

FIG. 2 is a schematic illustration of the changes in the cross section of the sniffer tube, and

FIG. 3 illustrates the pressure curve along the length of the tube.

The following description of an embodiment should be understood as being only exemplary. It does not limit the scope of protection of the invention. Rather, the same is defined by the claims.

FIG. 1 illustrates a leak detector comprising a sniffer probe 10 designed, for example, in the manner of a pistol and having an inlet opening at the inlet end 11. The sniffer probe 10 is connected to a sniffer tube 12 configured as a throttling capillary line. The capillary extends up to the inlet end 11 of the pistol. The outlet end of the sniffer tube 12 is connected to a vacuum chamber 13 evacuated by a high-vacuum pump 14. The vacuum chamber 13 is connected to a mass spectrometer 15 with which the sample gas to be detected, e.g. helium, is found.

Atmospheric pressure prevails at the inlet 11 of the sniffer probe 10. The effect of the vacuum chamber 13 reduces the pressure along the sniffer tube to 60 mbar, for example.

FIG. 2 illustrates the cross-sectional profile of the inner cross section of the sniffer tube over the length of the tube. The illustration is not to scale. The sniffer tube is divided in individual portions 12a, 12b and 12c. The first portion 12a facing the inlet has a small cross section, the next portion 12b has a larger cross section, and the third portion 12c has an even larger cross section. Thus, the highest pressure drop occurs at the portion 12a. in the following portions 12b, 12c, the pressure drops are lesser so that the short dead times are obtained.

The flow qₚᵥ and the dead time Tₜₒₜ of a capillary can be calculated as follows: Here, it is assumed that the flow is laminar:

$$\begin{matrix}{q}_{pv} = \frac{õ {d}^{4}}{256 l η} ( {p}_{1}^{2} - {p}_{2}^{2} ) ( Hagen \text{-} Poiseuille formula ) & ( 1 ) \\ {τ}_{tot} = \frac{{õ}^{2} {d}^{6}}{1536 l η {q}_{qv}^{2}} ( {p}_{1}^{3} - {p}_{2}^{3} ) & ( 2 )\end{matrix}$$

Here, p₁ and p₂ are the pressures at the ends of the capillary, d is the diameter, l is the length of the capillary, and η is the dynamic viscosity of the respective gas, generally air.

This calculation shows that the flow through a hose of 5 m in length and a constant diameter of continuously 800 μm for the pressures p₁=1000 mbar and p₂=60 mbar is qₚᵥ=330 sccm. The dead time is Tₜₒₜ=305 ms in this case.

According to the invention, the line of a total length of 5 m is composed of, for example, three portions having the following dimensions:
12a length: 160 cm, diameter: 636 μm
12b length: 162 cm, diameter: 950 μm
12c length: 178 cm, diameter: 1410 μm

The flow through each portion and correspondingly through the entire length of the tube is qₚᵥ=330 sccm. The dead time is 214 ms.

Thus, the dead time can be reduced by at least 30% by using three assembled portions.

FIG. 3 illustrates the curve of the pressure P along the length l of the tube. It is evident that the strongest pressure drop occurs in the first tube portion 12a, whereas the pressure drop is lesser in the following tube portions.

1. A leak detector comprising a sniffer probe (10) that is connected with a vacuum chamber (13) through a sniffer tube (12) designed as a throttling capillary line,
characterized in that
the sniffer tube (12) has an inner cross-sectional surface varying in the longitudinal direction, the cross-sectional surface increasing in the flow direction of the gas aspirated.

2. The leak detector of claim 1, wherein the sniffer tube (12) is composed of a plurality of portions (12a, 12b, 12c), each of which has a constant cross section.

3. The leak detector of claim 1 or 2, wherein the diameter of the smallest cross section is not larger than 700 μm.

4. The leak detector of one of claims 2 to 4, wherein each portion conveys at least approximately the same flow, the flow being determined by the formula
$${q}_{pv} = \frac{õ {d}^{4}}{256 l η} ( {p}_{1}^{2} - {p}_{2}^{2} )$$
where p₁ and p₂ are the pressures at the ends of the capillary, d is the diameter, l is the length of the capillary, and η is the dynamic viscosity of the relevant gas.
